(19) United States
(12) Patent Application Publication
(10) Pub. No.: US 2025/0189325 A1
(43) Pub. Date: Jun. 12, 2025

(54) DRIVING INFORMATION DISPLAY APPARATUS AND METHOD FOR PROVIDING CHARGING STATION RECOMMENDATION INFORMATION BY CONSIDERING SUPPLY AND DEMAND

(71) Applicants: Hyundai Motor Company, Seoul (KR); Kia Corporation, Seoul (KR); Hyundai Autoever Corp., Seoul (KR)

(72) Inventors: Tae Heon Kim, Hwaseong-si (KR); Jaeseok Park, Hwaseong-si (KR); Geumdan Jin, Hwaseong-si (KR); Taehyun Sung, Hwaseong-si (KR); Hanshik Kim, Hwaseong-si (KR); Sang Jun Lee, Hwaseong-si (KR); WonMi Ahn, Seoul (KR); Jin Young Min, Seoul (KR); HwaHyeon Hong, Seoul (KR); Lam Lee, Seoul (KR)

(21) Appl. No.: 18/966,263

(22) Filed: Dec. 3, 2024

(30) Foreign Application Priority Data
Dec. 7, 2023 (KR) 10-2023-0176556

(51) Int. Cl. G01C 21/34

(52) U.S. Cl. CPC G01C 21/3476; G01C 21/3469; G01C 21/3492

(57) ABSTRACT

In a driving information display apparatus and method for providing charging station recommendation information by considering supply and demand, the driving information display apparatus can include a processor configured to receive driving guidance information and vehicle location information and perform control to output a guidance screen corresponding to the driving guidance information, and a storage unit configured to store road information and algorithms driven by the processor. The driving guidance information can include route information including charging station route guidance generated based on destination information, target remaining charge level information, and the supply level information of one or more charging stations for each zone located on a route to a destination among a plurality of zones.

### CROSS-REFERENCE TO RELATED APPLICATIONS

The present application claims priority to Korean Patent Application No. 10-2023-0176556 filed on Dec. 7, 2023, the entire contents of which are incorporated herein for all purposes by this reference.

### TECHNICAL FIELD

The present disclosure relates to a driving information display apparatus and method for providing charging station recommendation information by considering supply and demand.

### BACKGROUND

There are many cases where it is difficult to drive an electric vehicle comfortably due to a long charging time and an insufficient number of charging stations in terms of the characteristics thereof. Accordingly, there is a demand for a route guidance service that considers the battery states of electric vehicles and guides them to charging stations.

In response to this, U.S. Pat. No. 9,170,118 entitled “Navigation System for Electric Vehicle” discloses technology that changes a guidance route by considering a remaining battery charge level at each location while guiding an electric vehicle through its route. In this technology, a target remaining battery charge level is set for its destination so that the vehicle can safely drive next when the vehicle arrives at the destination, and route guidance on driving via a charging station is provided to help to achieve this goal.

However, in this prior art, a charging station is recommended based only on the conditions and driving route of a vehicle, so that there is a problem in that charging demand can be concentrated in a specific area, with the result that charging waiting times can be long and drivers experience inconvenience while charging. Therefore, there is a demand for technology that predicts as accurately as possible the time required to use an actual charging station and provides route guidance, including a passage via the charging station, based on the predicted time.

The information included in this Background of the Present Disclosure is only for enhancement of understanding of the general background of the present disclosure and may not be taken as an acknowledgement or any form of suggestion that this information forms the prior art already publicly known, available, or in use.

### SUMMARY

The present disclosure relates to a driving information display apparatus and method for providing charging station recommendation information by considering supply and demand, and more particularly to a system and method for recommending an electric vehicle charging station based on information related to the demand and supply of electric vehicle charging stations for each zone set based on geographic information.

An embodiment of the present disclosure can provide guidance on an optimal driving route by considering the charging waiting time and charging time of an electric vehicle.

An embodiment of the present disclosure can accurately predict charging waiting time and charging time by analyzing the demand and supply of charging stations.

An embodiment of the present disclosure can accurately predict charging waiting time and charging time for each zone by analyzing the states of one or more charging stations in each zone using geographic information.

An embodiment of the present disclosure can provide route guidance intended to reach a destination as fast as possible by predicting the total time required through the additional consideration of the time required to move to another charging station when the waiting time at a charging station is long.

An embodiment of the present disclosure can set zones and cluster charging stations by using geographic information to facilitate the analysis of supply and demand.

The problems to be solved as an example embodiment of the present disclosure are not necessarily limited to the problems described above, and solutions to other problems by a an embodiment of the present disclosure may be clearly understood by those skilled in the art from the following detailed description of the present disclosure.

According to various embodiments of the present disclosure, a driving information display apparatus can include: a processor configured to receive driving guidance information and vehicle location information and perform control to output a guidance screen corresponding to the driving guidance information; and a storage unit configured to store road information and algorithms driven by the processor, and the driving guidance information can include route information including charging station route guidance generated based on destination information, target remaining charge level information, and the supply level information of one or more charging stations for each zone located on a route to a destination among a plurality of zones.

The plurality of zones may be set so that the difference in a total road length within each zone does not exceed a predetermined reference value. The supply level information of the charging stations for each zone may include charging station density information obtained by dividing the number of charging stations present in each zone by a total road length in each zone.

The supply level information of the charging stations for each zone may include information related to the accessibility between charging stations derived by calculating the driving time between individual charging stations within each zone with real-time traffic information reflected therein.

The supply level information of the charging stations for each zone may include information related to accessibility obtained based on the driving time taken to move to a charging station in a nearby zone when there is only one charging station in each zone.

The charging station route guidance may be generated by considering the expected charging waiting time information for each zone calculated based on charging demand information for each zone and the expected charging time information for each zone calculated based on the charging capacity information of the charging stations for each zone.

The charging demand information for each zone may be derived based on the route information and charging state information of a plurality of electric vehicles.

According to various embodiments of the present disclosure, a driving information management server can be equipped with a central processing unit and memory, and the driving information management server can include: a connection setup unit configured to set up connections to exchange information with the driving information display apparatuses of a plurality of electric vehicles; a supply level information derivation unit configured to derive the supply level information of a plurality of charging stations for each zone; a driving guidance information generation unit configured to receive destination information and target remaining charge level information from any one of the plurality of electric vehicles over a set-up connection, and to generate driving guidance information including charging station route guidance using the received destination information, the received target remaining charge level information, and the supply level information for each zone located on a route to a destination among a plurality of zones; and a driving guidance information transmission unit configured to transmit the generated driving guidance information to the electric vehicle.

The plurality of zones may be set so that the difference in total road length within each zone does not exceed a predetermined reference value. The supply level information of the charging stations for each zone may include charging station density information obtained by dividing the number of charging stations present in each zone by a total road length in each zone.

The supply level information of the charging stations for each zone may include information related to the accessibility between charging stations derived by calculating the driving time between individual charging stations within each zone with real-time traffic information reflected therein.

The supply level information of the charging stations for each zone may include information related to accessibility obtained based on the driving time taken to move to a charging station in a nearby zone when there is only one charging station in each zone.

The driving guidance information generation unit may be further configured to generate the charging station route guidance by considering the expected charging waiting time information for each zone calculated based on charging demand information for each zone and the expected charging time information for each zone calculated based on the charging capacity information of the charging stations for each zone.

The charging demand information for each zone may be derived based on the route information and charging state information of the plurality of electric vehicles.

The methods and apparatuses of embodiments of the present disclosure can have other features and advantages that can be apparent from or are set forth in more detail in the accompanying drawings, which are incorporated herein, and the following Detailed Description, which together serve to explain certain principles of example embodiments of the present disclosure.

### BRIEF DESCRIPTION OF THE DRAWINGS

FIG. 1 is a block diagram showing the internal configuration of a driving information display device according to various example embodiments of the present disclosure;

FIG. 2 is a block diagram showing the internal configuration of a driving information management server according to various example embodiments of the present disclosure;

FIG. 3 is a diagram showing an example in which a map is divided into zones to generate route guidance information that is provided by a driving information display apparatus according to various example embodiments of the present disclosure;

FIG. 4 is a diagram showing an example in which a supply level for each zone is calculated to generate route guidance information that is provided by a driving information display apparatus according to various example embodiments of the present disclosure;

FIG. 5 is a diagram showing an example in which information related to accessibility for each zone is calculated to generate route guidance information that is provided by a driving information display apparatus according to various example embodiments of the present disclosure;

FIG. 6 is a diagram showing an example in which an optimal route is selected from route candidates that can be provided by a driving information display apparatus according to various example embodiments of the present disclosure;

FIG. 7 is a diagram showing the overall flow of a process of generating driving guidance information including route guidance in a driving information display apparatus according to various example embodiments of the present disclosure; and

FIG. 8 is a flowchart showing the flow of a driving information display method according to various example embodiments of the present disclosure.

It may be understood that the appended drawings are not necessarily to scale, presenting a somewhat simplified representation of various features illustrative of the basic principles of the example embodiments of the present disclosure. The specific design features of the example embodiments of the present disclosure as included herein, including, for example, specific dimensions, orientations, locations, and shapes can be determined in part by the particularly intended application and use environment.

In the figures, reference numbers can refer to same or equivalent parts of example embodiments of the present disclosure throughout the several figures of the drawing.

### DETAILED DESCRIPTION OF ILLUSTRATIVE EMBODIMENTS

Reference will now be made in detail to various example embodiments of the present disclosure, which are illustrated in the accompanying drawings and described below. While the present disclosure will be described in conjunction with example embodiments of the present disclosure, it can be understood that the present description is not intended to necessarily limit the present disclosure to those example embodiments of the present disclosure. On the other hand, the present disclosure is intended to cover not only the example embodiments of the present disclosure, but also various alternatives, modifications, equivalents and other embodiments, which may be included within the spirit and scope of the present disclosure as defined by the appended claims.

Example embodiments of the present disclosure will be described in detail below with reference to the accompanying drawings. In the following description of example embodiments of the present disclosure, when it is determined that a detailed description of any related known configuration or function may obscure the gist of the present disclosure, the detailed description can be omitted. In the following description of the example embodiments of the present disclosure, specific numerical values are only examples, and the scopes of the present disclosure are not necessarily limited thereby.

In the following descriptions of the components of the example embodiments of the present disclosure, terms such as “first,” “second,” “A,” “B,” “(a),” “(b),” and so forth, may be used. These terms can be used merely to distinguish corresponding components from other components, and the natures, sequential positions, and/or orders of the corresponding components are not necessarily limited by these terms. Unless defined otherwise, terms used herein, including technical or scientific terms, can include a same meaning as commonly understood by those skilled in the art to which an example embodiment of the present disclosure pertains. Terms such as those defined in commonly used dictionaries can be interpreted as having meanings consistent with the meanings in the context of related art, and should not be interpreted as having ideal or excessively formal meanings unless explicitly defined in the present application.

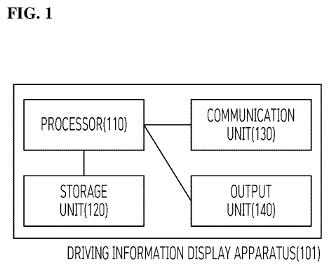

Example embodiments of the present disclosure will be described in detail below with reference to FIGS. 1 to 8.

FIG. 1 is a block diagram showing the internal configuration of a driving information display apparatus 101 according to various example embodiments of the present disclosure.

The driving information display apparatus 101 according to the example embodiment may be provided inside a transportation system such as a vehicle, or may be implemented in a detachable form. The driving information display apparatus 101 may generally include the form of a vehicle navigation system, an audio, video and navigation (AVN) system, a head-up display (HUD), or the like, and may be implemented in a form in which an application is provided on a mobile phone terminal such as a smartphone, for example.

The driving information display apparatus 101 according to the example embodiment may be present in a form of a server outside a transportation system such as a vehicle. The driving information display apparatus 101 may be implemented to generate driving guidance information by processing determinations while being present outside a transportation system and to output the driving guidance information to a display present inside the transportation system. Various embodiments may be implemented. The scope of rights of the present disclosure is not necessarily limited by the forms of such implementations.

The driving information display apparatus 101 of the example embodiment may operate in conjunction with devices for autonomous driving control such as an advanced driver assistance system (ADAS), a smart cruise control (SCC) system, a forward collision warning (FCW) system, and/or the like.

As shown in the drawing, the driving information display apparatus 101 according to the example embodiment may include a processor 110, a storage unit 120, a communication unit 130, and an output unit 140.

The processor 110 can be configured to control the storage unit 120, the communication unit 130, and the output unit 140 to execute an application, process data according to the algorithm defined in the application, communicate with an external module, and provide the results of the processing to a user.

The processor 110 may refer to a chip for processing a general algorithm, such as a central processing unit (CPU) or an application processor (AP), or a set of such chips. The processor 110 may refer to a chip optimized for floating-point arithmetic, such as a general-purpose computing on graphics processing unit (GPGPU), to process an artificial intelligence algorithm such as deep learning, or a set of such chips. Alternatively, the processor 110 may refer to a module in which various types of chips perform an algorithm and process data in a connected and distributed manner.

The processor 110 may be electrically connected to the storage unit 120 (storage medium) and the communication unit 130, may electrically control the individual components, may be an electric circuit that executes software commands, and may perform various types of data processing and determination to be described later. The processor 110 may be, for example, an electronic control unit (ECU), a micro-controller unit (MCU), or another lower level controller that is mounted on a transportation system.

The storage unit 120 can be a storage medium that can store road information and an algorithm executed by the processor. The road information may include map information, road traffic condition information, and/or the like. Depending on the configuration of the driving information display apparatus 101 of the present disclosure, the form or amount of road information stored inside the driving information display apparatus 101 may vary.

In some cases, the storage unit 120 may store road information including the map information and traffic condition information of all serviceable areas and provide services based on the road information. Alternatively, the storage unit 120 may temporarily store only road information related to a location where guidance is being made and provide services based on the temporarily stored road information.

This may be implemented as a different form depending on the form in which the driving information display apparatus 101 according to an example embodiment of the present disclosure is implemented inside or outside a transportation system, the communication method used, the storage space of the storage unit 120, and/or input/output speed. This is a part that may be chosen autonomously by those skilled in the art depending on the implementation situation. The scope of rights of the present disclosure is not necessarily limited by such changes in implementations.

The road information stored in the storage unit 120 may include not only general road information but also information for the provision of guidance on entrances, exits, parking locations, and/or the like within indoor sections such as underground parking lots.

The road information stored in the storage unit 120 may include various types of display information to be displayed in guidance information. The display information may include various types of information to be included in the guidance information displayed in driving situations, such as intersections, traffic lights, crosswalks, destinations, and major landmarks. The display information included in the road information may include parking locations, entrance locations, ramps for movement between floors, indoor facilities, road information outside indoor sections connected to exits, and/or the like for the purpose of guidance inside indoor sections. Such display information may each be composed of a combination of the name of the display information to be displayed as guidance information and information related to the location where the corresponding display information can be displayed.

The storage unit 120 may have various forms, and may be at least one type of storage medium such as a flash memory-, hard disk-, micro-, card (e.g., secure digital (SD) card)-, extreme digital (XD) card-, random access memory (RAM)-, static RAM (SRAM)-, read-only memory (ROM)-, programmable ROM (PROM)-, electrically erasable PROM (EPROM)-, magnetic memory (MRAM)-, magnetic disk-, or optical disk-type storage medium, or the like, or any combination thereof, for example. Depending on the amount, processing speed, storage time, and/or the like of data to be stored, a different type of storage medium or a combination of different types of storage media may be chosen.

The algorithm stored in the storage unit 120 may be implemented as a computer program in an executable form, and may be implemented to be stored in the storage unit 120 and then executed in a required situation. The algorithm stored in the storage unit 120 may be interpreted as including an instruction form that is temporarily loaded into volatile memory and instructs the processor to perform specific operations.

The communication unit 130 can receive information for driving guidance from the outside of the driving information display apparatus 101 of the present disclosure over a wired/wireless communication network, and transmits necessary information to an external module.

The communication unit 130 may receive road information stored in the storage unit 120, an algorithm executed by the processor 110, and the like from an external module, and may transmit information related to the current state of a transportation system to the outside to obtain necessary information related to the transmitted information. For example, the communication unit 130 may continuously receive traffic information from a traffic information server to check real-time traffic information, and can be configured to transmit the location and route information of a transportation system, found through a module such as a Global Positioning System (GPS) receiver, to the outside to obtain the real-time traffic information of an area related to the location and route of the transportation system.

The communication unit 130 can be a hardware device that is implemented using various electronic circuits to transmit and receive signals over a wireless or wired connection. In an example embodiment of the present disclosure, the communication unit 130 may perform communication within a transportation system using infra-transportation means network communication technology, and may perform Vehicle-to-Infrastructure (V2I) communication with a server, infrastructure, another transportation system, and/or the like outside a transportation system using wireless Internet access or short-range communication technology. The communication within a transportation system may be performed using Controller Area Network (CAN) communication, Local Interconnect Network (LIN) communication, FlexRay communication, and/or the like as the infra-transportation means network communication technology. Such wireless communication technology may include wireless LAN (WLAN), Wireless Broadband (WiBro), Wi-Fi, Worldwide Interoperability for Microwave Access (WiMAX), etc. Moreover, the short-range communication technology may include Bluetooth, ZigBee, Ultra-wideband (UWB), Radio Frequency Identification (RFID), Infrared Data Association (IrDA), etc.

The output unit 140 may output augmented reality information that is controlled by executing the algorithm, stored in the storage unit 120, by the processor 110. Augmented reality is a technology for enabling related information to be provided by adding graphic information to an image or scene of the real world.

The output unit 140 may be implemented as a head-up display (HUD), a cluster, an audio, video and navigation (AVN) system, a human-machine interface (HMI), and/or the like. The output unit 140 may include at least one of a liquid crystal display (LCD), a thin film transistor liquid crystal display (TFT LCD), a light emitting diode (LED) display, an organic light emitting diode (OLED) display, an active matrix OLED (AMOLED) display, a flexible display, a bended display, and a three-dimensional (3D) display. Some of these displays may be implemented as a transparent display configured in a transparent or translucent form to be able to view the outside thereof. The output unit 140 may be provided as a touch screen including a touch panel, and may be used as an input device as well as an output device.

In the present disclosure, the vehicle may be described as being based on a concept including various transportation systems. In some cases, the vehicle may be interpreted as being based on a concept including not only various means of land transportation, such as cars, motorcycles, trucks, and buses, which drive on roads, but also various transportation systems, such as airplanes, drones, ships, etc.

Accordingly, in the present disclosure, the electric vehicle may be interpreted as being based on a concept including various transportation systems that store electric energy in a secondary battery and use it as a power source among various transportation systems.

The driving information display apparatus 101 according to an embodiment of the present disclosure may have different example embodiments depending on the driving guidance information processed by the processor 110. Accordingly, the generation of the driving guidance information received by the processor 110 and the information included in the driving guidance information will be described by way of example below.

As described above, the processor 110 can perform control to receive driving guidance information and information related to the location of an electric vehicle and output a guidance screen corresponding to the driving guidance information. The driving guidance information may include a variety of types of information. When a driver sets a destination and wants to receive guidance information related to it through a screen, the driving guidance information may include information related to the destination and a route leading to the destination. Various types of other information for the driving guidance of a vehicle may be included in the driving guidance information.

In particular, in a case of an electric vehicle, the driving distance can be short, charging can take a long time, and there can be not a sufficient number of charging stations, so that it can be important to provide guidance on an optimal route passing through a charging station during route guidance. Accordingly, the processor 110 may be configured to provide guidance on an optimal route along which a driver may safely drive to a destination while charging an electric vehicle at a necessary point by using electric vehicle charging station information included in the map information stored in the storage unit 120.

In a case of regular vehicles other than electric vehicles, it can be common to provide guidance on the fastest one of various routes that can reach a destination. In a case of electric vehicles, drivers may want to be guided along the fastest route to reach their destination. However, the charging time of electric vehicles can be longer than that of regular vehicles and the difference in total time required varies depending on the standby state of a charging station, charging speed, and the amount of electricity to be charged, so that there can be difficulty in finding the fastest route.

In a case of fossil fuel vehicles, the refueling time and the waiting time at a gas station are generally short, so that the difference in total time required attributable to the selection of a gas station is not significant no matter which gas station a driver selects to refuel a vehicle on his or her route. However, in a case of electric vehicles, the waiting time and the charging time can vary significantly depending on the electric charging station, so that, when a charging station is selected inappropriately on a driving route, total time required can become significantly long. Accordingly, it may be necessary to provide route guidance that includes a passage via a charging station to minimize the total time required for charging.

In particular, in a case of long-distance driving, it can become more difficult to predict the state of a charging station through which an electric vehicle will pass, so that there can be a need for a method of predicting the state of a charging station as accurately as possible. For example, in a case of long-distance driving, when it is necessary to drive for about two hours to reach the electric vehicle charging station selected as a passage point, it can be difficult to predict how long it will take to wait at the charging station selected as a passage point after two hours and how long it can take to charge the vehicle as needed and drive again.

When vehicles are crowded at the charging station selected as a passage point after two hours, the waiting time for charging can be longer. In particular, the charging time for each electric vehicle can be long, so that it can take a lot of time to wait for the vehicle being charged to complete charging, which can take an incomparably longer time than the waiting time for the refueling of a regular vehicle.

When many electric vehicles are crowded at a charging station selected in advance as a passage point, resulting in a long waiting time, it may be desirable to move to another nearby charging station and charge the vehicle. However, because the vehicle has already driven for two hours before arriving, the charging stations to which it can travel can be inevitably limited. Accordingly, in addition to predicting the waiting time and charging time of a specific charging station, the total time required may be accurately calculated by considering the possibility of selecting an alternative charging station depending on the situation and the time required for it. In other words, it can be necessary to analyze not only an individual charging station but also the situation in the area around the charging station, especially the supply and demand for the charging station and the possibility of moving to an alternative charging station, and use the results of the analysis to generate route guidance.

The driving guidance information processed by the processor 110 may include route information including destination information, target remaining charge level information, and charging station route guidance generated based on the supply level information of a charging station for each zone located on a route to a destination among a plurality of zones. As described above, it can be difficult to predict the exact total time required and generate efficient route information only by analyzing the situation of an individual charging station.

Accordingly, in an embodiment of the present disclosure, optimal route information may be generated by setting zones based on geographic information, clustering charging stations within each of the zones, and analyzing information related to demand and supply for the charging station and accessibility between charging stations within the corresponding zone.

In an embodiment of the present disclosure, a plurality of zones can be set so that the difference in total road length within each zone does not exceed a predetermined reference value. There may be various ways to divide an overall map into multiple zones. The easiest way is to divide a map into a grid and form the grid in a tile structure so that each cell has the same area.

However, when districts are divided in this way, the central area of a city, a mountainous area, a rural area, a coastal area, etc. are all divided into the same size. In a zone, there may be complex roads and multiple charging stations, and in another area, there may not even be a road. It may be impossible or difficult to efficiently analyze supply and demand for each zone.

Accordingly, in an embodiment of the present disclosure, zones can be set so that the difference in total road length within each zone does not exceed a predetermined reference value. The reference value may be determined in the form of a ratio. When the reference value is set to a lower value, the difference in total road length within each zone can be small, so that efficient management can be possible, but it can take a lot of effort to divide an overall area into zones. In contrast, when the reference value is set to a higher value, an overall area may be easily divided into zones, but the differences between zones may become severe, so that effective analysis can be difficult.

For example, when the overall country of Korea is a target for a map, each zone can be set to a considerably small area in a case of the downtown of Seoul where roads are dense, and each zone can be set to a considerably large area in a place where there are not many roads, such as a rural or mountainous area.

When zones are set based on the total road length, the total distances along which an electric vehicle can drive within the respective zones can become the same. The numbers of charging stations in respective zones, the numbers of electric vehicles entering respective zones, and the driving times required to move from one charging station to other charging stations within each zone may be compared using the same criteria.

To divide an overall map into zones so that the total road lengths thereof are approximately the same, overall map information and overall road information can be required. Accordingly, it can be necessary to manage zones by constructing and continuously updating a geographic information database 202 including map information and road information.

When there are map information and road information, the task of dividing a map into zones based on them may be performed by applying various algorithms. Although each of the zones can be generally formed in a rectangular shape, there is no reason for an embodiment of the present disclosure to be necessarily limited to a specific shape.

Supply level information and demand information can be derived for each of the zones set in the above manner, and the charging waiting time and charging time required when an electric vehicle is charged within the zone may be calculated using the derived supply level information and demand information. Accordingly, the total time required may be calculated by adding up the driving time to each zone, the calculated charging waiting time, and the calculated charging time.

Charging station supply level information for each of the zones can be information indicating how easily a charging station can be used within the zone, and may be quantified and then provided in a numerical form. As the density of charging stations is higher in the zone, the supply level may be evaluated higher. As it is easier to move between charging stations and find an alternative charging station, the supply level may be evaluated higher.

First, the density of charging stations within a zone can be calculated by dividing the total number of charging stations within the zone by the total road length for each zone. Accordingly, the density of charging stations can be determined to be the number of charging stations per unit road and individual zones can be set to have similar total road lengths, so that the number of charging stations in the zone actually represents the density of charging stations.

The number of charging stations can refer to the number of chargers that can charge electric vehicles. In a case where chargers that can charge electric vehicles are limited depending on the type of vehicle, the density of charging stations may be calculated as the number of chargers that can charge an electric vehicle that will use driving guidance information. It can be desirable to check state information such as current availability for each charger and calculate the density of charging stations using the number of only available chargers.

In a case of electric vehicle charging stations, charging speeds can be various. When a driver designates the minimum charging speed of a charging station to be used in advance, the density of charging stations may be calculated only for chargers in the charging station having a charging speed higher than the designated minimum charging speed.

When there is an available time for each charging station, this may be checked, and the density of charging stations may be calculated based on only the chargers in the charging station available at the time when an electric vehicle is expected to arrive in a corresponding zone.

Accordingly, the density of charging stations may not be fixed for each zone, but may vary depending on the type of electric vehicle, a driver's personality, usage time, and/or the like, so that the density of charging stations can be calculated by checking a current situation upon generating driving guidance information.

Information related to the supply level of charging stations for each zone can include information related to the accessibility between charging stations, which can be derived by calculating the driving time between individual charging stations within each zone by reflecting real-time traffic information therein. In other words, this can be intended to determine how long it takes to move between the charging stations in the zone. When the electric vehicle can rapidly move to an alternative charging station in a case where an initial target charging station is not available when the electric vehicle arrives in the zone, the zone may be determined to have a high charging station supply level.

When there is only one charging station in a zone, this can be used in accessibility information obtained based on the driving time required to move to a charging station in an adjacent zone. In a case where one charging station is unavailable when there is only the charging station in a zone, it can be impossible to move to another charging station in the zone, so that it may be necessary to find and move to another charging station in an adjacent zone. Accordingly, the driving time required to move to a charging station in an adjacent zone can be used as information related to accessibility between charging stations.

In particular, the accessibility between charging stations may vary depending on road conditions. In urban areas where traffic congestion can be severe and driving can take a long time, the accessibility between charging stations can be low (or relatively lower). In quiet suburban areas, the accessibility between charging stations can be high (or relatively higher).

When the accessibility is calculated simply based on congestion, the accessibility in urban areas may appear to be high, as described above. However, in urban areas, there can be many roads, so that it can be expected that each zone can be narrow and the density of charging stations can be high, with the result that it may take a short time to move to a nearby charging station.

In suburban areas, an electric vehicle may move rapidly per unit of time, but a zone can be relatively large and there can be a high possibility that it can be necessary to drive a long distance to find a charging station. Accordingly, to comprehensively determine this, it can be desirable to calculate and utilize the time required to move between individual chargers by considering real-time traffic information.

Charging station route guidance included in route information can be generated by considering expected charging waiting time information for each zone calculated based on charging demand information for each zone and expected charging time information for each zone calculated based on the charging capacity information of one or more charging stations for each zone. Even when a charging station supply level is high so that there are many chargers and movement between chargers is convenient, waiting time can inevitably be long when there are many electric vehicles that use chargers. Accordingly, the expected charging time can be calculated by determining charging demand information for each zone and analyzing how fast a charging demand can be met in each zone based on the charging demand information.

Charging demand information for each zone can be derived based on the route information and charging state information of a plurality of electric vehicles. To this end, the charging demand information may be derived by receiving driving route information including destinations and passage points from the driving information display apparatuses 101 of the plurality of electric vehicles and then determining the number of electric vehicles scheduled to arrive at each zone and each charging station within the zone through the statistical analysis of the driving route information.

To derive accurate charging demand information, each zone may be set as a destination or passage point, the arrival times of electric vehicles expected to use charging stations in the zone may be predicted, and the number of electric vehicles that will arrive in the zone at the expected arrival time of an electric vehicle that will display driving guidance information may be calculated.

The charging time it can take for electric vehicles to be charged in each zone may be predicted by organizing the charging capacity information of one or more charging stations in the zone into a database and then using this database.

For example, in a case where an electric vehicle that can generate driving guidance information wants to arrive in a specific zone in one hour and charge itself, when there is only one charging station in the zone, there can be one electric vehicle (a first vehicle) that arrives 40 minutes later, and there can be one electric vehicle (a second vehicle) that arrives 50 minutes later, it may be predicted that the first vehicle will charge itself with electricity for 30 minutes and the second vehicle will charge itself with electricity for 20 minutes based on the charging capacity of the charging station in the zone. When the electric vehicle that will generate driving guidance information arrives one hour later, it may be expected that the first vehicle can need to charge itself for an additional 10 minutes in the state of having already charged itself for 20 minutes and the waiting second vehicle can need to charge itself for another 20 minutes thereafter. Accordingly, the arrived electric vehicle can wait for charging for 30 minutes after arrival and then charge itself for 30 minutes, so that it can spend a total of one hour at the charging station in the zone.

When the time required to pass through another charging station in a nearby zone is shorter than one hour, it can be desirable to provide route guidance so that the vehicle can charge itself in the other zone and then move from the zone.

In this manner, in the process of generating driving guidance information, route candidates that can be used to drive to a destination are derived, analysis can be performed on multiple zones that can be passed through for each of the route candidates, and the total time required for the route candidate can be calculated by adding up predicted charging station waiting time and charging time and total driving time for charging in each of the zones.

The route candidate requiring the minimum time may be selected for route guidance to be included in the driving guidance information by comparing the total times required for the respective route candidates, and the output unit 140 may be controlled to output the guidance information by using the route guidance.

In this manner, when accurate charging time and accurate charging waiting time are calculated by analyzing demand prediction for each zone, the actual time required may be minimized compared to simply providing guidance to minimize driving time, so that efficient driving is enabled.

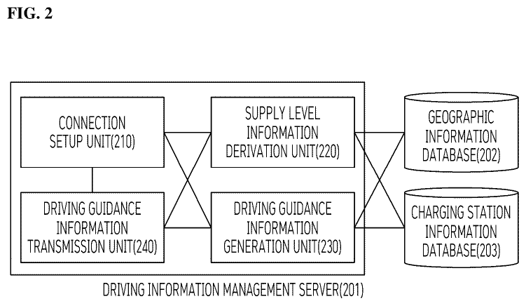

FIG. 2 is a block diagram showing the internal configuration of a driving information management server according to various example embodiments of the present disclosure.

A driving information management server 201 according to various example embodiments of the present disclosure can be a server equipped with a central processing unit (CPU) and memory, and may include a standalone server and/or a cloud. The driving information management server 201 is not necessarily limited to a specific configuration as long as the driving information management server 201 can obtain a target remaining battery charge level by processing the information received from the above-described driving information display apparatus 101 over a wired or wireless communication network and transmit the target remaining battery charge level back to the driving information display apparatus 101 over a communication network, for example.

The driving information management server 201 of an embodiment of the present disclosure can process the computation required to generate the charging guidance information displayed on the driving information display apparatus 101. Accordingly, the process of generating charging guidance information in the driving information display apparatus 101 described above may be performed in the driving information management server 201. Therefore, the descriptions of the process of generating charging guidance information displayed on the driving information display apparatus 101 may be applied to the driving information management server 201 without significant change, and vice versa.

The driving information display apparatus 101 described above may connect to the driving information management server 201 over a communication network, may transmit the destination information and driving-related information, entered by a driver, to the driving information management server 201, and may display guidance information based on the driving guidance information received from the driving information management server 201.

As shown in FIG. 2, the driving information management server 201 of an embodiment of the present disclosure may include a connection setup unit 210, a supply level information derivation unit 220, a driving guidance information generation unit 230, and a driving guidance information transmission unit 240, and may further include a geographic information database 202 and a charging station information database 203 or be configured to operate in conjunction with the geographic information database 202 and the charging station information database 203, any of, any combination of, or all of which may be in plural or may include plural components thereof.

The connection setup unit 210 can set up connections to exchange information with the driving information display apparatuses 101 of a plurality of electric vehicles. The connection setup unit 210 can set up connections with the communication units 130 of the driving information display apparatuses 101 over a wired or wireless communication network, and is not necessarily limited to a specific type of communication.

The supply level information derivation unit 220 can derive the supply level information of charging stations for each plurality of zones. The plurality of zones can be set so that the difference in total road length within each zone does not exceed a predetermined reference value. The zones can be set so that the total road lengths for the respective zones are similar to each other, so that the lengths of roads along which an electric vehicle can drive within the respective zones can be made similar to each other as much as possible and supplies and demands can be more accurately compared between the zones.

To set zones so that the total road lengths for the respective zones are similar to each other, map information and road information can be required. To this end, the map information of an overall map and road information on the map may be stored in the geographic information database 202, and the map may be divided into zones by using the stored map information and road information.

Various algorithms may be used to set zones so that the respective zones have similar total road lengths. The present disclosure is not necessarily limited to a specific method. The individual zones may be formed as rectangular shapes, and may be formed by dividing or merging administrative districts. In connection with the shapes of the zones, various other variations may be possible.

As long as the zones are set so that the difference in the total road length for each zone does not exceed the predetermined reference value and thus the total road lengths within the respective zones are similar to each other, variations including various zone setting methods and various zone shapes may also fall within the scopes of the present disclosure, for example.

The supply level of charging stations can refer to whether charging stations are supplied to be available to the drivers of electric vehicles within each zone. Information related to the supply level of charging stations may include information related to the density of charging stations and information related to the accessibility between charging stations. The density of charging stations can denote how often a driver can encounter charging stations while driving within a zone. The density of charging stations can be obtained by dividing the number of charging stations in each zone by the total road length in the zone. For example, when the total road length in the zone is 1 km and the number of charging stations is 5, the density of charging stations can be 5 charging stations/km.

As described above, the zones can be set so that the difference in total road length for each zone is minimized, so that the density of charging stations is actually determined according to the number of charging stations in the zone.

To store charging station information for each zone, information such as the locations and charging capacities of charging stations in an overall area may be cumulatively stored in the charging station information database 203 and the charging station information may be calculated using the stored information. The charging station information database 203 may obtain, process, and store charging station information from various sources. In addition to the purpose of calculating the density of charging stations, various types of charging station-related information may be stored for the purpose of providing driving information.

The information related to the supply level of charging stations for each zone derived by the supply level information derivation unit 220 can include information related to the accessibility between charging stations derived by calculating the driving time between individual charging stations within each zone by reflecting real-time traffic information therein. The information related to the supply level of charging stations for each zone can be derived by the supply level information derivation unit 220 and may include information related to the accessibility obtained based on the driving time to a charging station in a nearby zone when there is only one charging station in a specific zone, for example.

The fact that there is a high density of charging stations in a zone does not guarantee that a driver can easily use the charging stations. For example, during the rush hour in the central area of a city having severe traffic congestion, even when there are multiple charging stations in one zone, a lot of time can be inevitably spent in moving when one of the charging stations is in use and thus it can be necessary or desired to move to another charging station. The distance between charging stations can be short because the density of charging stations is high, but it can take a lot of time to move between charging stations, so that this is not a situation where a driver can comfortably use many charging stations.

Accordingly, the information related to the supply level of charging stations can include not only the density of charging stations but also the accessibility between charging stations. As described above, the information related to the accessibility between charging stations can be obtained based on the time it takes to move between charging stations in a zone. Based on real-time traffic information or traffic situation prediction information at the time when an electric vehicle is expected to enter the zone, the time it takes to drive between charging stations may be generated as the information related to the accessibility between charging stations.

Even in the same zone, the time it takes to move between charging stations can vary depending on time and traffic conditions, so that the information related to the accessibility between charging stations may need to be continuously updated.

In this manner, the information related to the supply level can include quantified information indicating information related to the density of charging stations and the accessibility between charging stations. As each element of the information related to the supply level can have a more positive value, a zone in question can be more convenient for a driver to use for a charging station. For example, it may be determined that as information related to the density of charging stations has a higher value, the supply level can be higher. It may be determined that as information related to the accessibility between charging stations has a lower value, the supply level can be higher.

Determining whether a driver can conveniently use each zone by determining the supply level using a plurality of parameters may be performed by calculating the weight of each of the parameters using various types of regression analysis or artificial intelligence models.

The driving guidance information generation unit 230 can receive destination information and target remaining charge level information from any one of a plurality of electric vehicles over the set-up connections, and generate driving guidance information, including charging station route guidance, using the received destination information, the received target remaining charge level information, and information related to the supply level for each zone located on a route to a destination among the plurality of zones.

Once the information related to the supply level has been calculated for each of the zones constituting the map, driving guidance information used to drive to a destination can be generated using the information related to the supply level. Destination information and target remaining charge level information, which can be information required to generate a driving route for a general electric vehicle, can be received and a route can be set based on the information.

The driving guidance information generation unit 230 can first derive a plurality of candidate routes used to drive from a starting point to a destination. When the electric vehicle drives directly to the destination along each of the derived candidate routes, an expected remaining charge level at the destination can be determined. When this value is lower than an entered target remaining charge level, the candidate route can be modified so that the electric vehicle can be charged and moved via a charging station along the candidate route.

The most efficient route may be selected from the candidate routes set to pass through a charging station, and may then be provided to a driver. The previously calculated charging station supply level information for each zone can be used.

First, a candidate route where a driver can conveniently charge his or her electric vehicle because charging station supply level information can be high in zones passed through by the driver when charging is required may be selected using the charging station supply level information of the zones passed through by the driver along each of the candidate routes when moving along the candidate route. It may be recommended that while the driver is moving along the candidate route, he or she sufficiently charges his or her electric vehicle in a zone having a high charging station supply level and then moves again.

A charging station to be passed through may be determined by additionally considering various types of information related to a charging station, such as the charging capacity, charging state and driver preference of the charging station along the route, and a route including the charging station may be calculated as a final route.

Considering the charging station supply level information in the driving guidance information generation unit 230 in this manner may maximize a driver's charging convenience compared to the conventional technology that does not consider a supply level.

However, it can be desirable for the driving guidance information generation unit 230 to check not only supply level information but also demand information. Even when the supply level of charging stations is sufficiently high in a zone, a driver may have to wait a long time for charging when a large number of electric vehicles are crowded in that zone to charge themselves.

For example, even in a case where a zone has a high density of charging stations (e.g., 5 per 1 km of road) and has excellent accessibility between charging stations, when a large number of electric vehicles are crowded and charging themselves in that zone while an electric vehicle is moving to the zone to charge itself, it can be often more efficient to charge an electric vehicle in another zone, where supply level information is not best, due to a low density of charging stations and poor accessibility between charging stations.

Accordingly, the driving guidance information generation unit 230 can calculate a final route by checking charging demand information as well as supply level information. The charging demand information may include information related to the number of electric vehicles expected to arrive in each zone for charging and the expected capacity to be charged for each vehicle.

The charging demand information for each zone can be calculated based on the route information and charging state information of a plurality of electric vehicles. The time when an electric vehicle that will provide driving guidance information will arrive in each zone can be predicted, and the number of electric vehicles that will arrive in that zone for charging at that time can be predicted. The charging capacity with which each electric vehicle will be charged in that zone can be predicted.

Because the driving information management server 201 can be connected to the driving information display apparatuses 101 of a plurality of electric vehicles and provide driving guidance information, the destination information of the plurality of electric vehicles, charging station information, the charging target information of the charging station, and/or the like may be checked. Accordingly, based on this information, there may be derived demand information related to the number of electric vehicles expected to arrive and charge themselves in each zone in a specific time span and the capacity with which each of the electric vehicles will charge itself.

The driving guidance information generation unit 230 can generate the charging station route guidance by considering the expected charging time information for each zone that is calculated based on the estimated charging waiting time information for each zone and the charging capacity information of charging stations for each zone calculated based on the charging demand information for each zone.

The charging station information for each zone stored in the charging station information database 203 can include various types of information related to one or more charging stations, such as the locations and charging speeds of the charging stations and/or the like. Accordingly, the time it takes for an electric vehicle to arrive and charge itself with a required charging capacity in each zone may be calculated.

Accordingly, the driving guidance information generation unit 230 may calculate the time it takes to wait for charging due to the charging of vehicles that have arrived earlier and the time it takes to complete charging when an electric vehicle that will provide driving guidance information arrives in each zone.

Once the charging waiting time and the charging time have been calculated in this manner, the total time required may be determined by adding up the calculated times and the total driving time on the candidate route. By calculating the total time required for each of the plurality of candidate routes and selecting a route having the shortest total time required, there may be provided driving route guidance that considers the actual time required, including charging waiting time and charging time at a charging station. It may be possible to generate optimum driving guidance information by using both the supply level information and the charging demand information described above.

The supply level information and the charging demand information may be combined in various forms. For example, data may be accumulated for each driver's trip by using the total time required, which can be derived from the charging demand information as parameters, and the supply level information (the density of charging stations and the accessibility between charging stations), an artificial intelligence model configured to derive a preferred route for each driver may be generated by using the accumulated data as training data, and a final route may be selected using the artificial intelligence model.

As another method, there may be generated a statistical model or artificial intelligence model that allows the total time required to be calculated by receiving supply level information together with information such as the number of vehicles to arrive and charging capacity when the total time required is generated using charging demand information. The supply level information may be utilized to calculate the total time required. In a case where the supply level is higher even when the same demand is present, the actual time required may be calculated as a lower value. Accordingly, in this manner, the total times required are accurately predicted, and a final route is selected from the plurality of candidate routes based on the total times required.

Various modifications may be applied to derive an optimal route for a driver by using supply level information and demand information separately or simultaneously, as described above.

The driving guidance information transmission unit 240 can transmit the generated driving guidance information to the electric vehicle. The communication unit 130 of the driving information display apparatus 101 of the electric vehicle can transfer the transmitted driving guidance information to the processor 110, and the processor 110 can control the output unit 140 to output a guidance screen corresponding to driving guidance information.

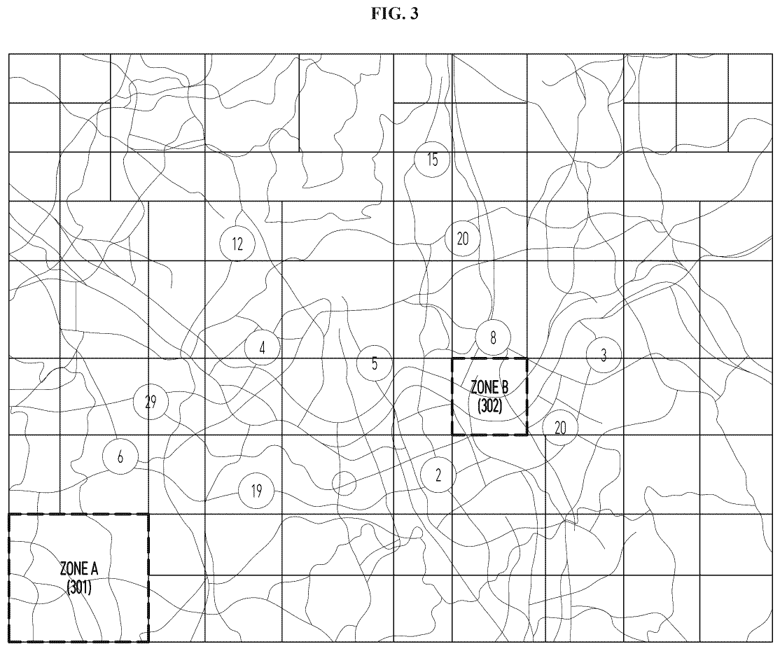

FIG. 3 is a diagram showing an example in which a map is divided into zones to generate route guidance information that is provided by a driving information display apparatus according to various example embodiments of the present disclosure.

As described above, in an embodiment of the present disclosure, guidance on an optimal route is provided by analyzing demand and supply information for each zone. For this purpose, it is important to effectively set zones.

When the method of setting zones to equal areas in a simple grid form can be used, an urban area having dense roads and a mountainous or rural area having few roads can be divided into zones by using the same criteria, so that it can be difficult to compare supplies and demands between the two areas. Accordingly, in various example embodiments of the present disclosure, a map can be divided into a plurality of zones so that the total road lengths within the respective zones are set to similar values. Although it can be preferable that a map is divided into a plurality of zones so that the total road lengths within the respective zones are set to the same value, it can be difficult to divide a map in this manner in reality. Accordingly, the total road lengths for the respective zones can be made to be as similar as possible by ensuring that the difference in total road length for each zone does not exceed the predetermined reference value.

As shown in the drawing, zone A 301 and zone B 302 can be different from each other in area. Zone B 302 is an urban area having many roads, and zone A 301 is a suburban area having sparse roads. Accordingly, the total road lengths of zone A 301 and zone B 302 can be set to almost the same value.

Accordingly, the supply and demand of each zone may be evaluated based on the total road length by using the same criteria. Through this, an optimal driving route may be selected, and guidance on the optimal driving route may be provided to a driver.

Various algorithms may be used to set zones so that the total road lengths are similar to each other in this manner. The easiest way can be to continue to divide an area into two halves based on the total road lengths. When an area is divided into two halves having the similar total road lengths alternately along the X and Y axes, multiple zones having the similar total road lengths may be generated.

The total road length in each zone may be set to an appropriate size to analyze supply and demand. When each zone is set to an excessive large size, the precise analysis of demand and supply at the zone level can be difficult. In contrast, when each zone is excessively small, the amounts of computation and data to be processed for each zone can increase, so that efficient processing can be difficult. Accordingly, the size of each zone may be determined from an operational perspective.

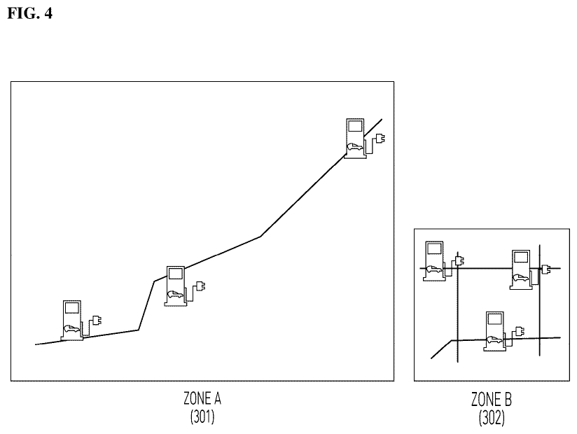

FIG. 4 is a diagram showing an example in which a supply level for each zone is calculated to generate route guidance information that is provided by a driving information display apparatus according to various example embodiments of the present disclosure.

This drawing is an enlarged view of each zone to check the supply level information of zone A 301 and zone B 302 shown in FIG. 3.

As described above, the supply level information for each zone can include information related to the density of charging stations and information related to the accessibility between charging stations. The density of charging stations can be obtained by dividing the number of charging stations in a zone by the total road length in the zone. In the drawing, zone A 301 and zone B 302 can be set so that the total road lengths thereof are similar to each other, as described above, and thus the density of charging stations in each zone is determined according to the number of charging stations in the zone.

For example, when each of zone A 301 and zone B 302 is set to a total road length of 3 km, the density of charging stations in each of zone A 301 and zone B 302 is 3/3 km=1/km. Accordingly, although there is a difference between the sizes of the zones, the densities of charging station in the two zones are determined to be the same.

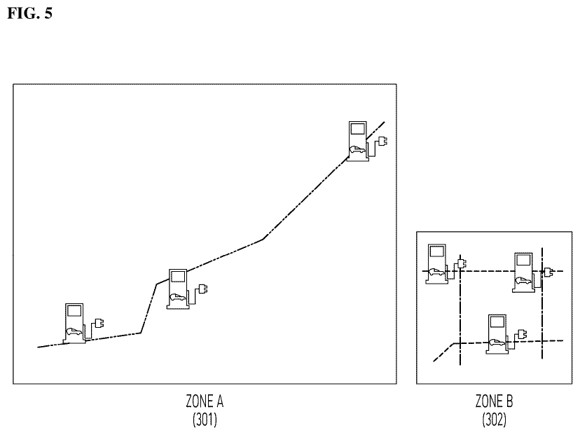

FIG. 5 is a diagram showing an example in which information related to accessibility for each zone can be calculated to generate route guidance information that is provided by a driving information display apparatus according to various example embodiments of the present disclosure.

This drawing is an enlarged view of each zone to check the supply level information of zone A 301 and zone B 302 shown in FIG. 3.

In the drawing, a red road color can indicate that a corresponding road is in a congested traffic state, a yellow road color can indicate that a corresponding road is in a delayed traffic state, and a green road color can indicate that a corresponding road is in a smooth traffic state, for example.

As previously discussed in conjunction with FIG. 4, zone A 301 and zone B 302 have the same density of charging stations. However, as shown in the drawing, in zone A 301, the distance between charging stations is long and the roads between charging stations are heavily congested, so that the time required to move between charging stations is long. In contrast, in zone B 302, charging stations are concentrated and there is no traffic congestion on the roads between charging stations, so that an electric vehicle can move between charging stations fast.

In other words, in zone B 302, when it is difficult to charge an electric vehicle or waiting time is long at an arrived charging station, it may be possible to move to another nearby charging station and charge the electric vehicle fast. In zone A 301, it takes a lot of time to move to another charging station, so that it takes a longer time to charge an electric vehicle within the zone.

Therefore, even though zone A 301 and zone B 302 have the same density of charging stations, it may be determined that zone B has a higher charging station supply level. This is calculated as information related to the accessibility between charging stations and included in the supply level information.

The information related to the accessibility between charging stations is obtained based on the time expected to take to drive to each charging station within the zone. When there are a plurality of charging stations, it can be calculated as the average time it takes to move from each of the charging stations to a nearby charging station.

When there is no charging station in a zone, the supply level will be set to the lowest value. When there is only one charging station in a zone, the accessibility between charging stations is set based on the driving time to the nearest charging station in a nearby zone, so that significantly poor charging station supply level information is obtained.

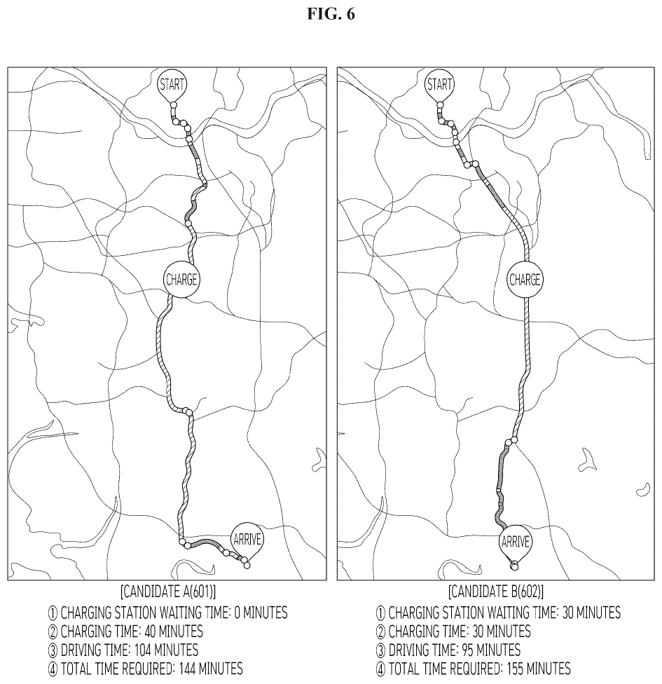

FIG. 6 is a diagram showing an example in which an optimal route is selected from route candidates that are provided by a driving information display apparatus according to various example embodiments of the present disclosure.

As shown in the drawing, the route information provided by the driving information display apparatus 101 is selected from a plurality of route candidates.

In FIG. 6, it can be assumed that an optimal path is selected from two routes, i.e., route candidate A 601 and route candidate B 602. The driving time for route candidate A 601 is 104 minutes, which is longer than the driving time for route candidate B 602. Accordingly, in the conventional art, the charging waiting time and the charging time at a charging station cannot be predicted, so that route candidate B 602 is determined to be a more appropriate route and is selected as a final route.

In contrast, when the actual charging station supply and demand information for each zone is analyzed using an embodiment of the present disclosure, the charging waiting time is o minutes for route candidate A 601, but is 30 minutes for route candidate B 602. Accordingly, the total time required for overall actual driving is 144 minutes for route candidate A 601, but is 155 minutes for route candidate B 602.

Therefore, the driving information display apparatus 101 of an embodiment of the present disclosure can provide guidance on route candidate A 601, along which an electric vehicle can actually arrive at a destination faster, as a final route. This can allow a driver to select the route along which he or she can drive to a destination fastest.

When a final route is selected, various types of information such as a driver's personality, charging cost, and another passage point may additionally be considered, and the total time required may be used as one of the parameters to be considered.

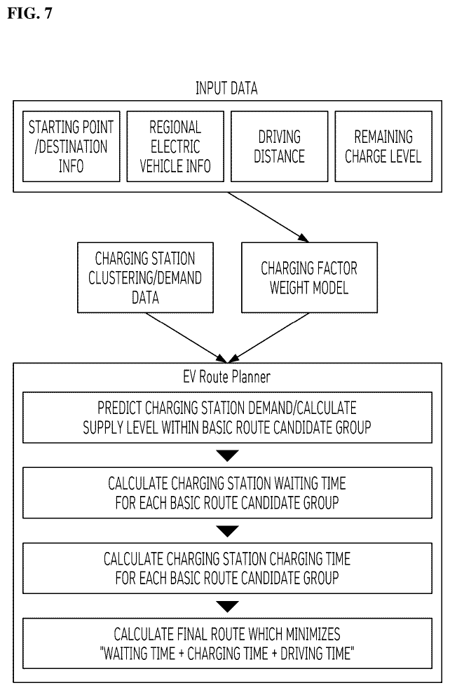

FIG. 7 is a diagram showing the overall flow of a process of generating driving guidance information including route guidance in a driving information display apparatus according to various example embodiments of the present disclosure.

As shown in FIG. 7, when a vehicle enters a destination and requests route guidance, it can receive various driving-related information such as information related to a starting point and the destination, per-area electric vehicle information, driving distance information, and remaining charge level information based on the entered data.

An electric vehicle charging feature (EV feature) weight model can be generated by constructing the above various types of information into a statistical or artificial intelligence model. Through this, there can be derived EV feature values that determine a charging station, charging time, and the amount of electricity to be charged depending on the situation.

As described above, the supply level information and charging demand information of a charging station cluster (zone) can be determined. As described above, supply information and charging demand information can be analyzed for each of the zones that are set so that the total road lengths thereof are similar to each other.

A final route can be calculated in a route design module (an EV route planner) by using the supply level and charging demand information for each charging station cluster (zone) and the EV feature weight values.

The route design module can calculate charging demand and supply level information for each zone through which a candidate route passes, and calculate charging station waiting time and charging time for each zone based on the charging demand and supply level information.

The total time required can be calculated by adding up the charging station waiting time and charging time calculated for each candidate route and the total driving time, and the candidate route that minimizes the total time required can be selected from all candidate routes as a final route. Accordingly, there may be provided a route that allows a driver to reach a destination fastest within the shortest time including the time taken to perform an overall charging process, in practice.

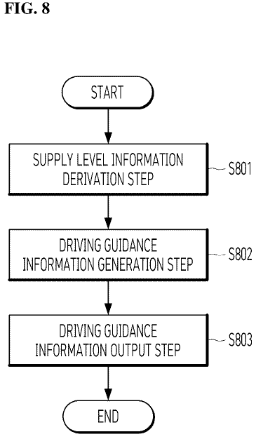

FIG. 8 is a flowchart showing the flow of a driving information display method according to various example embodiments of the present disclosure.

In the present example embodiment, the driving information display method according to an embodiment of the present disclosure can be a method that is performed by the driving information display apparatus 101 including the processor 110 and the storage unit 120 and the driving information management server 201. The components described above in conjunction with the operations of the driving information display apparatus 101 and the driving information management server 201 may be applied to the driving information display method without significant change. Accordingly, those skilled in the art may implement even the components, for which there are no specific descriptions in conjunction with the driving information display method below, by applying the foregoing descriptions of the driving information display apparatus 101 and the driving information management server 201.

In a supply level information derivation step S801, the supply level information of charging stations for each plurality of zones can be derived.

The plurality of zones can be set so that the difference in total road length within each zone does not exceed a predetermined reference value. The information related to the supply level of charging stations for each zone may include information related to the density of charging stations obtained by dividing the number of charging stations present in the zone by the total road length for the zone.

The information related to the supply level of charging stations for each zone derived in the supply information derivation step S801 may include information related to the accessibility between charging stations derived by calculating the driving times between the individual charging stations within each zone with real-time traffic information reflected therein.

In the supply information derivation step S801, when there is only one charging station in a zone, information related to accessibility can be derived based on the driving time taken to move to a charging station in a nearby zone.

In a driving guidance information generation step S802, destination information and target remaining charge level information can be received from any one of a plurality of electric vehicles over a set-up connection, and driving guidance information including charging station route guidance can be generated using the received destination information, the received target remaining charge level information, and the information related to the supply level for each zone located on a route to a destination among the plurality of zones.

In the driving guidance information generation step S802, the charging station route guidance can be generated by considering expected charging waiting time information for each zone calculated based on charging demand information for the zone and expected charging time information for the zone calculated based on the charging capacity information of charging stations for the zone. The charging demand information for each zone may be derived based on the route information and charging state information of a plurality of electric vehicles.

In a guidance information output step S803, control can be performed to output guidance information corresponding to the generated driving guidance information onto a screen. In the guidance information output step S803, the guidance information may be displayed directly through a display screen. A control signal may be transmitted so that a separate device displays guidance information through a display screen.

An embodiment of the present disclosure may achieve the advantage of providing guidance on an optimal driving route by considering the charging waiting time and charging time of an electric vehicle.

An embodiment of the present disclosure may achieve the advantage of accurately predicting charging waiting time and charging time by analyzing the demand and supply of charging stations.

An embodiment of the present disclosure may achieve the advantage of accurately predicting charging waiting time and charging time for each zone by analyzing the states of one or more charging stations in each zone using geographic information.

An embodiment of the present disclosure may achieve the advantage of providing route guidance intended to reach a destination as fast as possible by predicting the total time required through the additional consideration of the time required to move to another charging station when the waiting time at a charging station is long.

An embodiment of the present disclosure may achieve the advantage of setting zones and clustering charging stations to facilitate the analysis of supply and demand by using geographic information.

Various advantages that may be directly or indirectly understood by those skilled in the art may be provided throughout the present specification.

Although the present disclosure has been described with reference to the example embodiments, those skilled in the art may variously modify and change an embodiment of the present disclosure without departing from the spirit and scopes of the present disclosure described in the attached claims.

The control device may be at least one microprocessor operated by a predetermined program that may include a series of commands for carrying out the method included in the aforementioned various example embodiments of the present disclosure.

In various example embodiments of the present disclosure, each operation described above may be performed by a control device, and the control device may be configured by a plurality of control devices, or an integrated single control device.

In various example embodiments of the present disclosure, the memory and the processor may be provided as one chip, or provided as separate chips.

In various example embodiments of the present disclosure, the scopes of the present disclosure can include software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various example embodiments of the present disclosure, the control device may be implemented in a form of hardware or software, or may be implemented in a combination of hardware and software.

The terms such as “unit,” “module,” etc. included in the specification can be units for processing at least one function or operation, which may be implemented by hardware, software, or a combination thereof.

In an example embodiment of the present disclosure, the vehicle may be referred to as being based on a concept including various transportation systems. In some cases, the vehicle may be interpreted as being based on a concept including not only various means of land transportation, such as cars, motorcycles, trucks, and buses, that drive on roads but also various transportation systems such as airplanes, drones, ships, etc.

For convenience in explanation and accurate definition in the appended claims, the terms “upper,” “lower,” “inner,” “outer,” “up,” “down,” “upwards,” “downwards,” “front,” “rear,” “back,” “inside,” “outside,” “inwardly,” “outwardly,” “interior,” “exterior,” “internal,” “external,” “forwards,” and “backwards” can be used to describe features of the example embodiments with reference to the positions of such features as displayed in the figures. It can be further understood that the term “connect” or its derivatives can refer both to direct and indirect connection.

The term “and/or” may include a combination of a plurality of related listed items or any of a plurality of related listed items. For example, “A and/or B” can include all three cases such as “A,” “B,” and “A and B.”

In the present specification, unless stated otherwise, a singular expression can include a plural expression unless the context clearly indicates otherwise.

In example embodiments of the present disclosure, “at least one of A and B” may refer to “at least one of A or B” or “at least one of combinations of at least one of A and B.” Furthermore, “one or more of A and B” may refer to “one or more of A or B” or “one or more of combinations of one or more of A and B.”

In the example embodiment of the present disclosure, it can be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific example embodiments of the present disclosure have been presented for purposes of illustration and description. They are not intended to be exhaustive or to necessarily limit the present disclosure to the precise forms disclosed, and many modifications and variations can be possible in light of the above teachings. The example embodiments were chosen and described to explain certain principles of the present disclosure and practical applications, to enable others skilled in the art to make and utilize various example embodiments of the present disclosure, as well as various alternatives and modifications thereof. It is intended that the scope of the present disclosure be defined by the Claims appended hereto and their equivalents.

What is claimed is:

1. A driving information display apparatus comprising:
one or more processors; and
a storage medium configured to store road information and an algorithm configured to run by the one or more processors, and storing computer-readable instructions that, when executed by the one or more processors, enable the one or more processors to:
receive driving guidance information and vehicle location information, and
perform control to output a guidance screen corresponding to the driving guidance information, wherein the driving guidance information includes route information including charging station route guidance generated based on destination information, target remaining charge level information, and supply level information of one or more charging stations for each zone located on a route to a destination among a plurality of zones.

2. The apparatus of claim 1, wherein the plurality of zones are set so that a difference in a total road length within each zone does not exceed a predetermined reference value; and
wherein the supply level information of the charging stations for each zone includes charging station density information obtained by dividing a number of the charging stations present in each zone by the total road length in each zone.

3. The apparatus of claim 2, wherein the supply level information of the charging stations for each zone includes first accessibility information related to accessibility between the charging stations derived by calculating driving time between individual charging stations within each zone with real-time traffic information reflected therein.

4. The apparatus of claim 3, wherein the supply level information of the charging stations for each zone includes second accessibility information related to accessibility obtained based on driving time taken to move to a nearby charging station in a nearby zone in response to there being only one of the charging stations in each zone.

5. The apparatus of claim 1, wherein the charging station route guidance is generated by considering expected charging waiting time information for each zone calculated based on charging demand information for each zone and expected charging time information for each zone calculated based on charging capacity information of the charging stations for each zone.

6. The apparatus of claim 5, wherein the charging demand information for each zone is derived based on plurality route information and plurality charging state information of a plurality of electric vehicles.

7. A driving information management server comprising:
one or more processors; and
a storage medium configured to store computer-readable instructions that, when executed by the one or more processors, enable the one or more processors to:
set up connections to exchange information with driving information display apparatuses of a plurality of electric vehicles;
derive supply level information of a plurality of charging stations for each zone among a plurality of zones;
receive destination information and target remaining charge level information from a given electric vehicle of the plurality of electric vehicles over a set-up connection, and to generate driving guidance information including charging station route guidance using the received destination information, the received target remaining charge level information, and the supply level information for each of the plurality of zones located on a route of the given electric vehicle to a destination among the plurality of zones; and
transmit the generated driving guidance information to the given electric vehicle.

8. The server of claim 7, wherein the plurality of zones are set so that a difference in total road length within each of the plurality of zones does not exceed a predetermined reference value; and
wherein the supply level information of the charging stations for each of the plurality of zones includes charging station density information obtained by dividing a number of the charging stations present in each of the plurality of zones by the total road length in each of the plurality of zones.

9. The server of claim 8, wherein the supply level information of the charging stations for each of the plurality of zones includes first accessibility information related to accessibility between the charging stations derived by calculating driving time between individual charging stations within each of the plurality of zones with real-time traffic information reflected therein.

10. The server of claim 9, wherein the supply level information of the charging stations for each of the plurality of zones includes second accessibility information related to accessibility obtained based on driving time taken to move to a nearby charging station in a nearby zone when there is only one of the charging stations in each of the plurality of zones.

11. The server of claim 7, wherein the charging station route guidance includes considering expected charging waiting time information for each of the plurality of zones calculated based on charging demand information for each of the plurality of zones and expected charging time information for each of the plurality of zones calculated based on charging capacity information of the charging stations for each of the plurality of zones.

12. The server of claim 11, wherein the charging demand information for each of the plurality of zones is derived based on plurality route information and plurality charging state information of the plurality of electric vehicles.

13. A driving information display method, the method comprising:
deriving supply level information of charging stations for each zone among a plurality of zones;
receiving destination information and target remaining charge level information from a given electric vehicle among a plurality of electric vehicles;
generating driving guidance information including charging station route guidance using the received destination information, the received target remaining charge level information, and the supply level information for each zone located on a route of the given electric vehicle to a destination among the plurality of zones; and
transmitting the generated driving guidance information to the given electric vehicle.

14. The method of claim 13, further comprising:
setting the plurality of zones so that a difference in a total road length within each zone does not exceed a predetermined reference value;
obtaining charging station density information by dividing a number of the charging stations present in each zone by the total road length in each zone; and
obtaining the supply level information of the charging stations for each zone by including the charging station density information therein.

15. The method of claim 14, wherein the supply level information of the charging stations for each zone includes first accessibility information related to accessibility between the charging stations derived by calculating first driving times between individual charging stations within each zone with real-time traffic information reflected therein.

16. The method of claim 15, wherein the supply level information of the charging stations for each zone includes second accessibility information related to accessibility obtained based on a second driving time taken to move to a nearby charging station in a nearby zone when there is only one of the charging stations in each zone.

17. The method of claim 13, wherein the generating of the driving guidance information comprises generating the charging station route guidance by considering expected charging waiting time information for each zone calculated based on charging demand information for each zone and expected charging time information for each zone calculated based on charging capacity information of the charging stations for each zone.

18. The method of claim 17, wherein the charging demand information for each zone is derived based on plurality route information and plurality charging state information of the plurality of electric vehicles.

19. The method of claim 13, further comprising, in response to a driver designating a desired minimum charging speed of chargers, a density of the charging stations for the obtaining of the charging station density information is calculated only including the charging stations having the chargers capable of providing the desired minimum charging speed.

20. A non-transitory computer-readable storage medium having stored thereon a program that, when executed by a processor, causes the processor to execute the driving information display method of claim 13.
